(19) United States
(12) Patent Application Publication
(10) Pub. No.: US 2014/0059536 A1
(43) Pub. Date: Feb. 27, 2014

(54) MOBILE TERMINAL, INFORMATION PROCESSING APPARATUS, AND INFORMATION PROCESSING METHOD

(71) Applicant: Sony Corporation, Minato-ku (JP)

(72) Inventors: Yosuke HIRATSUKA, Tokyo (JP); Mototsugu Tsutsui, Kanagawa (JP)

(73) Assignee: Sony Corporation, Minato-ku (JP)

(21) Appl. No.: 13/971,161

(22) Filed: Aug. 20, 2013

(30) Foreign Application Priority Data
Aug. 27, 2012 (JP) 2012-187081
Sep. 28, 2012 (JP) 2012-218760

(51) Int. Cl. G06F 9/445

(52) U.S. Cl. CPC G06F 8/61
USPC 717/178

(57) ABSTRACT

A mobile terminal includes: a reception section configured to receive an application downloaded from a server by operation of a browser in an information processing apparatus and transmitted through the information processing apparatus; and a management section configured to install the application received by the reception section.

### BACKGROUND

The present technique relates to a mobile terminal, an information processing apparatus, and an information processing method. In particular, the present technique relates to a mobile terminal, an information processing apparatus, and an information processing method that make it possible to easily download applications.

What people call “smart phones”, which enable users to download applications in order to add favorite functions, are becoming widespread. The users are allowed to access a purchase site provided in accordance with an OS (Operating System) installed on their smart phones, and to search for favorite applications to download and install the applications.

A related-art technique has been disclosed on the Internet <http://www.sony.jp/walkman/products/NW-Z1000_series/feature_{—}4.html> (searched on Aug. 27, 2012).

### SUMMARY

In the future, it is thought that devices other than smart phones are provided with a function of downloading applications.

Such devices may be provided with a function of directly accessing a purchase site to download applications. However, for devices that are generally connected to a PC (Personal Computer) through a USB (Universal Serial Bus) cable, and so on, and allowed to exchange data with the PC, it is convenient to make it possible to download applications using a PC, and to install the applications into the devices.

The present technique has been made in view of such circumstances, and it is desirable to allow users to easily download applications.

According to an embodiment of the present technique, there is provided a mobile terminal including: a reception section configured to receive an application downloaded from a server by operation of a browser in an information processing apparatus and transmitted through the information processing apparatus; and a management section configured to install the application received by the reception section.

The mobile terminal further includes being connected to the information processing apparatus through a USB cable, wherein the reception section is configured to receive the application transmitted through the USB cable.

According to another embodiment of the present technique, there is provided a method of processing information, the method including: receiving an application downloaded from a server by operation of a browser in an information processing apparatus, and transmitted through the information processing apparatus; and installing the application received by a reception section.

According to another embodiment of the present technique, there is provided an information processing apparatus including: a display section configured to access a server, and to display a selection screen of an application for a mobile terminal by a browser function; and a transmission section configured to transmit the application selected on the selection screen and downloaded to the mobile terminal by a plug-in function of the browser.

The information processing apparatus further includes being connected to the mobile terminal through a USB cable, wherein the transmission section is configured to transmit the application through the USB cable.

According to another embodiment of the present technique, there is provided a method of processing information, the method including: accessing a server, and displaying a selection screen of an application for a mobile terminal by a function of a browser; and transmitting the application selected on the selection screen and downloaded to the mobile terminal by a plug-in function of the browser.

A network means a mechanism that connects at least two apparatuses, and enables one of the apparatuses to transmit information to the other of the apparatuses. Apparatuses that communicate through the network may be independent with each other, or may be internal blocks with each other that constitute one apparatus.

Also, communication means wireless communication and wired communication as a matter of course, and also includes mixed communication of a wireless communication system and a wired communication system. That is to say, communication may include a mixed system of a wireless communication system in a certain section and a wired communication system in the other section. Further, communication may include a system in which wired communication is performed from a certain apparatus to another apparatus, and wireless communication is performed from the other apparatus to the certain apparatus.

By the present technique, it is possible to download applications easily.

### BRIEF DESCRIPTION OF THE DRAWINGS

FIG. 1 is a diagram illustrating an example of a configuration of a network system according to an embodiment of the present technique;

FIG. 2 is a diagram illustrating an example of camera information;

FIG. 3 is a diagram illustrating an example of management information;

FIG. 4 is a flowchart illustrating purchase processing of an application;

FIG. 5 is a diagram illustrating an example of a portal screen;

FIG. 6 is a flowchart illustrating download processing of an application;

FIG. 7 is a flowchart illustrating download processing of an application, which is subsequent to FIG. 6;

FIG. 8 is a diagram illustrating an example of a message;

FIG. 9 is a diagram illustrating an example of a message;

FIG. 10 is a diagram illustrating an example of a message;

FIG. 11 is a diagram illustrating an example of a message;

FIG. 12 is a diagram illustrating an example of a message;

FIG. 13 is a diagram illustrating an example of a message;

FIG. 14 is a diagram illustrating an example of a detailed screen of an application;

FIG. 15 is a diagram illustrating examples of display of operation buttons;

FIG. 16 is a flowchart illustrating confirmation processing of an application;

FIG. 17 is a diagram illustrating an example of a message;

FIG. 18 is a diagram illustrating an example of a message;

FIG. 19 is a diagram illustrating an example of a message;

FIG. 20 is a diagram illustrating an example of a message;

FIG. 21 is a diagram illustrating an example of a message;

FIG. 22 is a diagram illustrating an example of a message;

FIG. 23 is a diagram illustrating an example of a message;

FIG. 24 is a block diagram illustrating an example of a hardware configuration of a PC;

FIG. 25 is a block diagram illustrating an example of a hardware configuration of a digital camera;

FIG. 26 is a block diagram illustrating an example of functional configurations of a PC and a digital camera; and

FIG. 27 is a block diagram illustrating an example of functional configurations of servers.

### DETAILED DESCRIPTION OF EMBODIMENTS

Network System Configuration

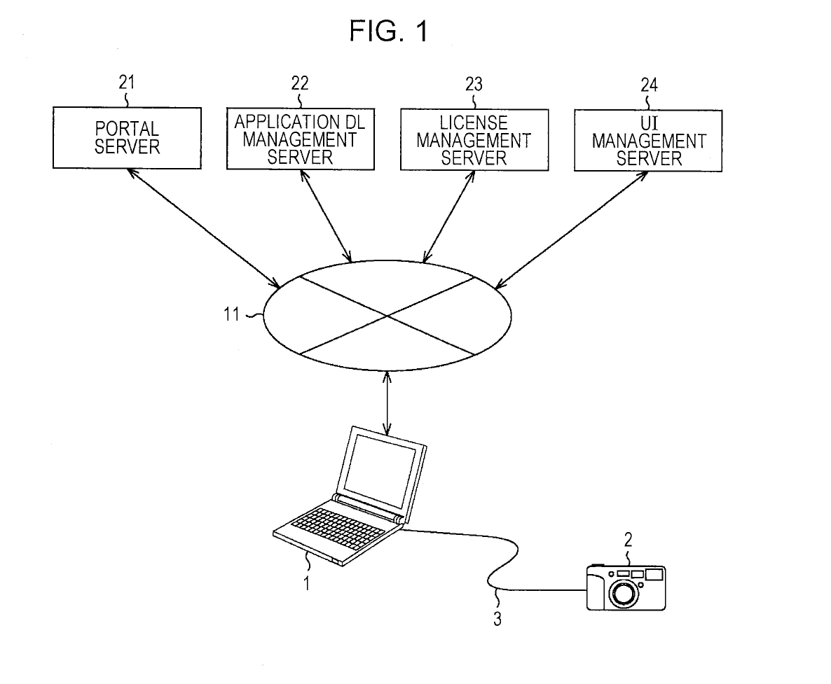

FIG. 1 is a diagram illustrating an example of a configuration of a network system according to an embodiment of the present technique.

The network system in FIG. 1 has a configuration in which a PC 1, a portal server 21, an application DL management server 22, a license management server 23, and a UI management server 24 are connected through a network 11, such as the Internet, and so on. A digital camera 2 is connected to the PC 1 through a USB cable 3. The digital camera 2 is possessed by a user of the PC 1, for example.

The PC 1 is provided with a browser, and is capable of accessing the servers connected to the network 11, and transmitting and receiving various kinds of information. For example, the PC 1 transfers an application for the digital camera 2, which has been downloaded from the application DL management server 22, to the digital camera 2 through the USB cable 3, and causes the digital camera 2 to install the application. A request for downloading the application is made by the browser of the PC 1, but an application file is transmitted and received between the digital camera 2 and the application DL management server 22 through the PC 1 (in a form not allowing the PC 1 to recognize the file). The network system in FIG. 1 is a system managed by a manufacturer of digital cameras, for example.

The digital camera 2 is a terminal on which an OS, such as Linux (a registered trademark), and so on has been installed, and performs communication with the servers through the PC 1. The PC 1 is provided with the browser and a downloader for performing communication with the digital camera 2 as a plug-in of the browser. Communications between the server and the digital camera 2 are achieved by functions of the browser and the downloader. The communications between the server and the digital camera 2 are performed by HTTPS (Hypertext Transfer Protocol over Secure Socket Layer), for example.

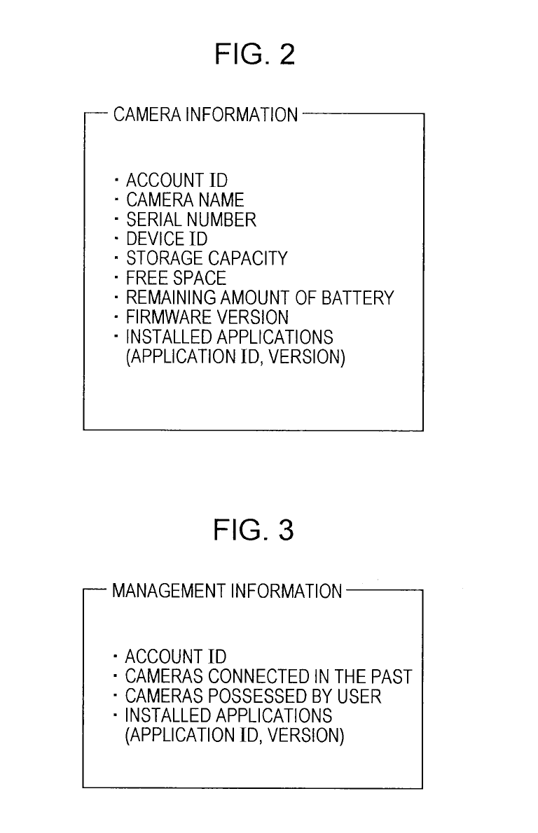

Camera information as illustrated in FIG. 2 is transmitted from the digital camera 2 to the portal server 21, for example. In the example in FIG. 2, the camera information includes an account ID, a name of the digital camera 2, a serial number, a device ID, a storage capacity, a free space of the storage, a remaining amount of the battery of the digital camera 2, and version information of the firmware of the digital camera 2. The camera information also includes installed application information, such as an application ID, a version, and so on.

The digital camera 2 installs the application, which has been downloaded from the application DL management server 22, and transferred from the PC 1. In the example in FIG. 1, the digital camera 2 is illustrated as a device connected to the PC 1. However, the other kinds of devices, such as a smart phone, a tablet terminal, a game machine, an electronic book, and so on may be connected to the PC 1. Also, the PC 1 and the digital camera 2 are connected through the USB cable 3. However, they may be connected through a cable of the other standards, or may be connected wirelessly.

The digital camera 2 included a communication function, such as a wireless LAN, and so on. The digital camera 2 may be connected to the network 11 through an access point, and may transmit and receive data directly to and from the servers without intervention of the PC 1.

The portal server 21 manages a portal site for downloading applications. Also, the portal server 21 manages information on digital cameras possessed by the users in association with account IDs of the users. It is necessary for each of the users to register information, such as an account ID, a password, an e-mail address, a credit card number to be used for paying the charges of the downloaded applications, and so on before downloading applications for the digital camera 2. The user information registered by the user is managed by the license management server 23, for example.

FIG. 3 is a diagram illustrating an example of management information managed by the portal server 21. In the example in FIG. 3, information on the cameras that were connected to the PC 1 in the past and information on the cameras possessed by the user are managed in association with an account ID. The camera information includes a serial number of a camera, a device ID, and a camera name. Also, in the example in FIG. 3, application IDs and version information of the applications having been installed in the cameras connected to the PC 1 in the past and the cameras possessed by the user are managed in association with an account ID.

As described later, the portal server 21 performs communication between the browser of the PC 1 and the digital camera 2, and achieves download of applications using the information illustrated in FIG. 2 and FIG. 3, and so on.

The application DL management server 22 manages download of applications.

The license management server 23 manages licenses of applications that the user has purchased in association with an account ID, and so on. For example, one application is allowed to be installed in 10 devices.

The UI (User Interface) management server 24 manages a UI used when a user of the PC 1 accesses a portal site managed by the portal server 21 from the browser. The management of the UI on the PC 1 is performed not only by the portal server 21, but also by the UI management server 24.

In the network system having such a configuration, it is possible for the user of the PC 1 to access the portal server 21 from the browser of the PC 1, and to operate a browser screen in order to install applications for the digital camera 2 into the digital camera 2.

Network System Operation

Here, a description will be given of operation of the network system in FIG. 1. The processing of the network system, illustrated in FIG. 1, on downloading applications for the digital camera 2, mainly includes purchase processing of applications and download processing of the purchased applications.

Purchase Processing of Applications

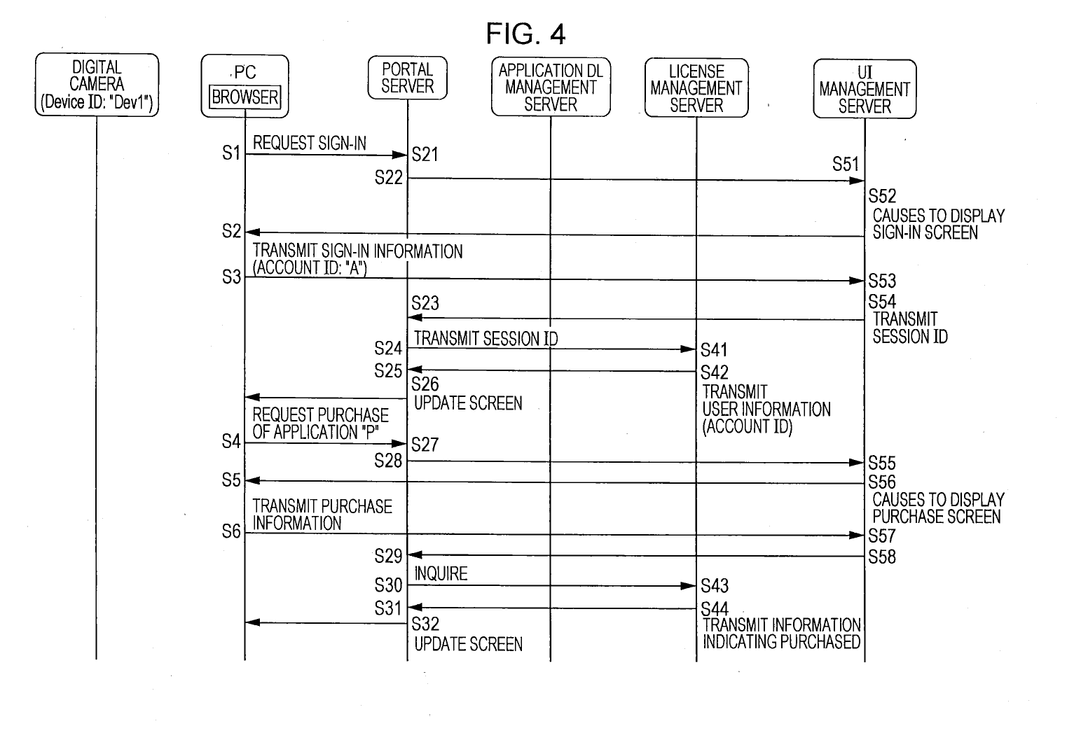

First, a description will be given of application purchase processing with reference to a flowchart in FIG. 4. Hereinafter it is assumed that an account ID by which the user of the PC 1 has registered is “A”, and a device ID of the digital camera 2 is “Dev1”. Also, it is assumed that the user purchases an application “P”.

The processing in FIG. 4 is started when the user of the PC 1 starts the browser to access the portal server 21, for example. When the user accesses the portal server 21, a portal screen is displayed on a display of the PC 1. The digital camera 2 may be connected to the PC 1, or may not be connected.

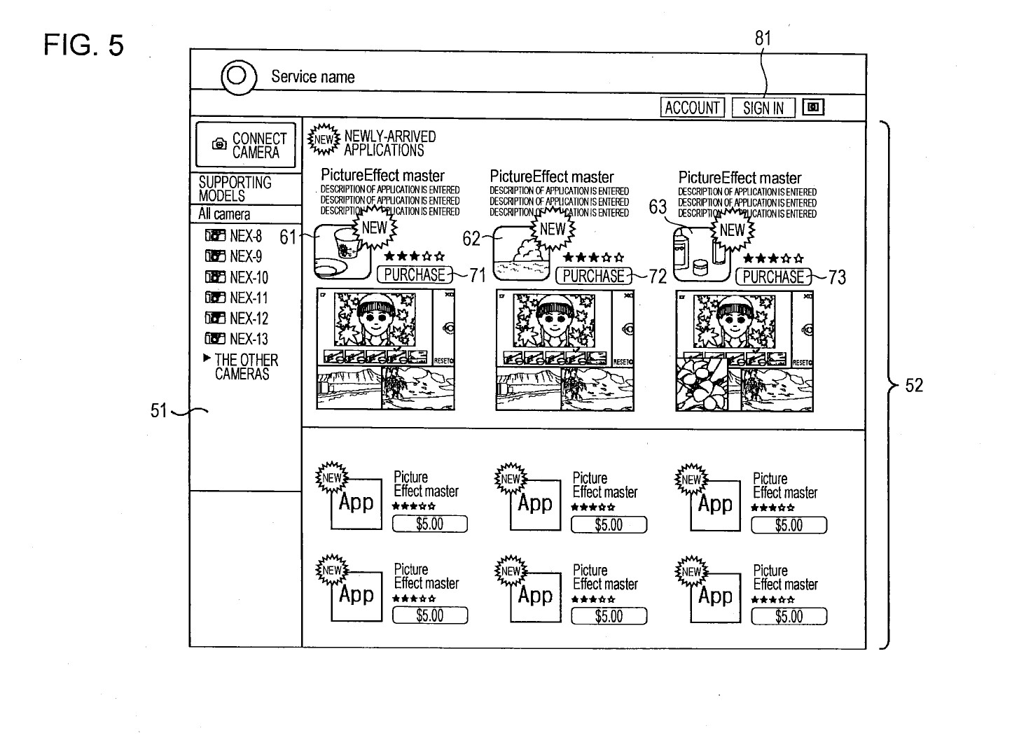

FIG. 5 is a diagram illustrating an example of a portal screen. The portal screen mainly includes a model information display section 51 and an application information display section 52.

In the model information display section 51, icons (images) representing outer views of digital cameras are displayed in a vertical arrangement, and model names are displayed on the right of the individual icons. Before signing in, the icons representing outer views of the digital cameras that are put on the market by the manufacturer managing the network system in FIG. 1 are displayed in order from new one in the model information display section 51, for example. In the example in FIG. 5, model names and icons of NEX-8, NEX-9, NEX-10, NEX-11, NEX-12, and NEX-13 are displayed in sequence from the top.

The icons representing applications capable of being downloaded and the descriptions thereof are arranged for display in the application information display section 52. In the example in FIG. 5, icons 61 to 63 that represent newly-arrived applications are enlarged and highlighted for display. Buttons thereof 71 to 73 are displayed on the right of the icons 61 to 63, respectively.

For example, an application name, and a description of an application function are displayed above the icon 61, and a button 71 to be operated at the time of purchasing the application identified by the icon 61 is displayed on the right of the icon 61. A character string “Purchase” is displayed on the button 71. An image representing the application function is displayed under the icon 61 and the button 71.

Icons representing various applications are also displayed under the portal screen. The user is allowed to confirm details of the applications, or to purchase the applications by selecting a predetermined application from such a portal screen. Also, a sign-in button 81 to be operated when the user signs in the network system in FIG. 1 is displayed on the upper right of the portal screen.

When the sign-in button 81 is pressed in a state in which the browser displays such a portal screen, the browser of the PC 1 transmits information representing a sign-in request to the portal server 21 in step S1.

In step S21, the portal server 21 receives the information transmitted from the browser of the PC 1, and in step S22, the portal server 21 transmits the received information to the UI management server 24.

In step S51, the UI management server 24 receives the information transmitted from the browser of the PC 1 through the portal server 21, and, in step S52, the UI management server 24 displays a UI for sign-in on the portal screen.

In step S2, the browser of the PC 1 displays the UI (sign-in screen) for sign-in under the control of the UI management server 24. For example, an input screen of an account ID and a password is displayed on the display of the PC 1. When the account ID and the password are input, in step S3, the browser of the PC 1 transmits the account ID (“A”) and the password to the UI management server 24.

In step S53, the UI management server 24 receives the account ID and the password that have been transmitted from the browser of the PC 1, and transmits the session ID to the portal server 21 in step S54. The account ID and the password that have been transmitted from the browser of the PC 1 are transmitted from the UI management server 24 to the license management server 23 with a session ID, for example, and authentication is performed using pre-registered information.

In step S23, the portal server 21 receives the session ID that has been transmitted from the UI management server 24, and transmits the session ID to the license management server 23 in step S24.

In step S41, the license management server 23 receives the session ID that has been transmitted from the portal server 21. In step S42, if authentication using the account ID and the password has been successful, the license management server 23 transmits information, such as an account ID, a password, and so on of the user of the PC 1 to the portal server 21.

In step S25, the portal server 21 receives the information transmitted from the license management server 23, and updates the portal screen in step S26.

For example, the portal server 21 displays the account ID at a predetermined position, and so on so as to notify the user of completion of the sign-in.

Also, the portal server 21 changes the arrangement of the icons displayed in the model information display section 51 such that icons representing the cameras possessed by the user and icons representing cameras that were connected to the PC 1 in the past are displayed with priority. As described with reference to FIG. 3, the portal server 21 manages information on the cameras that were connected to the PC 1 in the past in association with an account ID, and so on. For example, if NEX-10, which is a name of a camera possessed by the user, is managed in association with an account ID “A”, only the model name of NEX-10 and the icon are displayed in the model information display section 51.

Further, the portal server 21 changes the arrangement of the icons displayed in the application information display section 52 such that the icons representing applications capable of being installed in the cameras possessed by the user and icons representing cameras that were connected to the PC 1 in the past are displayed with priority. Only the icons representing applications that can be installed may be displayed in the application information display section 52.

The display of a portal screen is changed so that the user is allowed to easily search for applications supported by the digital camera 2 possessed by the user.

If the user has selected purchase of an application “P” by pressing the button (the button on which the character “Purchase” is displayed), and so on, the browser of the PC 1 transmits the information requesting purchase of application to the portal server 21 in step S4. The information transmitted to the portal server 21 includes identification information of the application “P”.

In step S27, the portal server 21 receives information transmitted from the browser of the PC 1, proceeds to step S28, and transmits the received information to the UI management server 24.

In step S55, the UI management server 24 receives the information transmitted from the portal server 21, and causes the PC 1 to display the UI for the purchase of the application in step S56.

In step S5, the browser of the PC 1 displays the UI (purchase screen) for purchasing an application under the control of the UI management server 24. For example, the purchase screen including detailed information of the application selected by the user is displayed on the display of the PC 1. A purchase button to be operated when instructing purchase of the application, and so on is also displayed on the purchase screen.

When the purchase button is pressed, the browser of the PC 1 transmits the purchase information requesting purchase of the application to the UI management server 24 in step S6.

In step S57, the UI management server 24 receives the purchase information transmitted from the browser of the PC 1, and transmits information representing reception of the purchase information to the portal server 21 in step S58. The purchase information transmitted from the browser of the PC 1 is, for example, transmitted from the UI management server 24 to the license management server 23, is subjected to accounting processing, and so on, and then the information representing purchased application is managed in association with the account ID.

In step S30, the portal server 21 inquires of the license management server 23 whether the purchase has been complete or not.

In step S43, the license management server 23 receives the inquiry from the portal server 21, and transmits information representing purchase completion to the portal server 21 in step S44.

In step S31, the portal server 21 receives the information from the license management server 23, and updates the display of the portal screen in step S32. For example, the portal server 21 changes the character on the button displayed adjacent to the icon representing completion of purchase from “Purchase” to “Install”, and so on to update the display of the portal screen.

Before purchase information of an application is transmitted (before step S6), if the portal server 21 has obtained the camera information of the digital camera 2 connected to the PC 1, it is possible for the portal server 21 to confirm whether the application requested to be purchased is supported by the digital camera 2 or not. If the application requested to be purchased is not supported by the digital camera 2, the portal server 21 causes to display a message stating not supported on the portal screen. A description will be given of processing for confirming whether an application is supported by the digital camera 2 or not before purchasing the application with reference to FIG. 20 and after that.

Also, it is possible to display additional information of the application necessary at purchase time of the application on the purchase screen displayed in step S5, and so on.

Application Download Processing

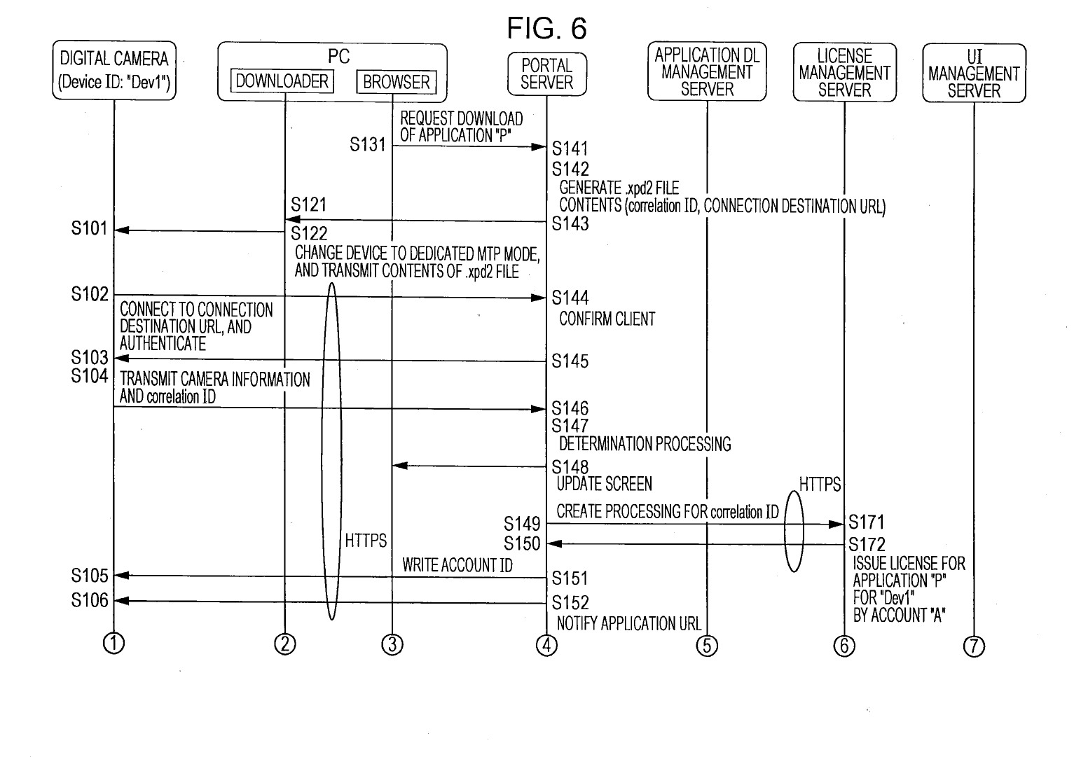

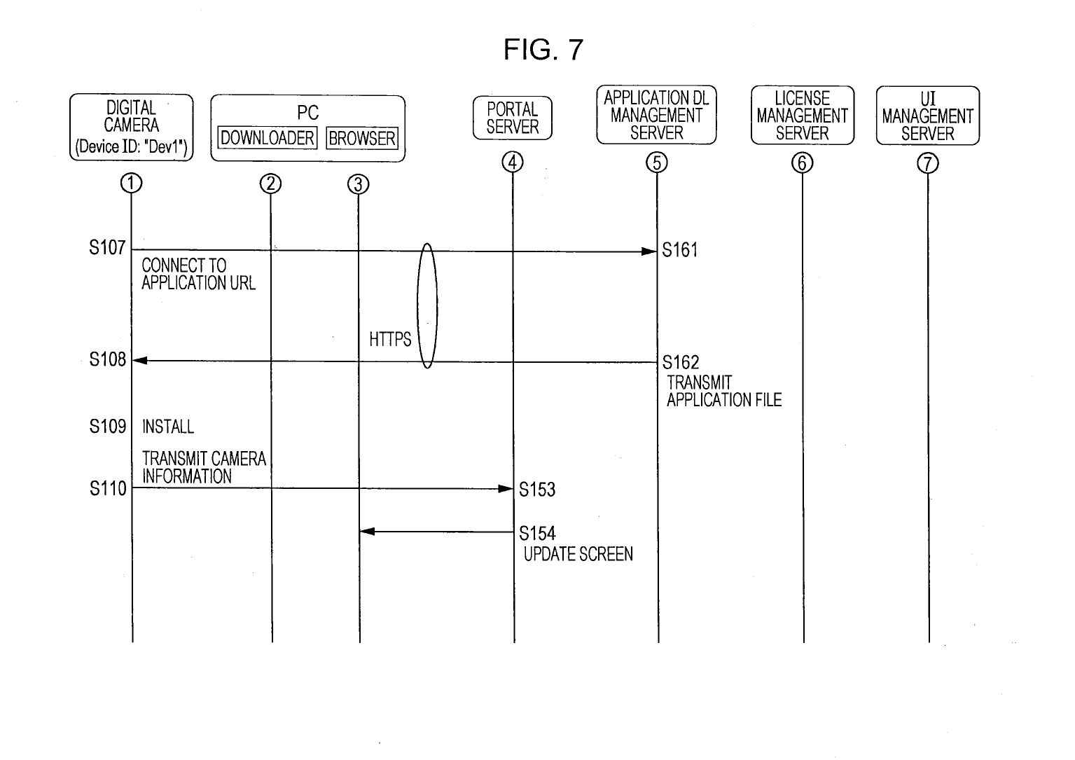

Next, a description will be given of download processing with reference to flowcharts in FIG. 6 and FIG. 7.

Processing in FIG. 6 and FIG. 7 is started, for example, when the user of the PC 1 who has purchased an application by the processing in FIG. 4 has started downloading of the purchased application. When the user has purchased an application, a button to be operated to instruct to start downloading the application is displayed on the display of the PC 1. Here, it is assumed that sign-in has been completed, and before instructing to download an application, the user of the PC 1 has connected the digital camera 2 to the PC 1.

In step S131, the browser of the PC 1 transmits information representing a request of downloading the application to the portal server 21 in response to the operation by the user.

In step S141, the portal server 21 receives the information transmitted from the browser of the PC 1. In step S142, the portal server 21 generates a .xpd2 file. The .xpd2 file included a correlation ID, and a connection destination URL. The connection destination URL indicates a connection destination for authentication of the digital camera 2. In step S143, the portal server 21 transmits the .xpd2 file to the PC 1.

In step S121, the downloader of the PC 1 starts in response to the transmission of the .xpd2 file. In step S122, the downloader changes the digital camera 2 to the MTP (Media Transfer Protocol) mode, and transfers the correlation ID and the connection destination URL included in the .xpd2 file to the digital camera 2.

In step S101, the digital camera 2 receives the information transmitted from the PC 1.

In step S102, the digital camera 2 accesses the portal server 21, which is a connection destination specified by the connection destination URL, and causes to perform authentication of the digital camera 2 by a predetermined method.

In step S144, the portal server 21 performs authentication of the digital camera 2.

If the portal server 21 has confirmed a client, the portal server 21 transmits information representing successful authentication to the digital camera 2 in step S145. If the authentication has failed, the portal server 21 causes the display of the PC 1 to display a message stating that the application is unable to be downloaded.

In this regard, if a downloader has not been installed in the PC 1, the information transmitted from the portal server 21 in step S143 is not transferred from the PC 1 to the digital camera 2, and the portal server 21 does not perform authentication of the digital camera 2. In this case, the portal server 21 transmits downloader data to the browser of the PC 1, causes the browser to install the downloader as a plug-in, and then performs processing of step S143 and after that.

In step S103, the digital camera 2 receives the information transmitted from the portal server 21, and transmits the camera information (FIG. 2) and the correlation ID to the portal server 21 in step S104.

In step S146, the portal server 21 receives the camera information and the correlation ID transmitted from the digital camera 2, and performs various kinds of determination processing using the camera information in step S147. In step 147, the portal server 21 updates the portal screen in accordance with a result of the determination processing.

For example, the portal server 21 changes the arrangement of the icons displayed in the model information display section 51 such that the icon representing the digital camera 2 connected to the PC 1 is displayed at the top.

Also, the portal server 21 changes the arrangement of the icons displayed in the application information display section 52 such that icons representing applications capable of being installed in the digital camera 2 are displayed with priority. Only the icons representing applications capable of being installed in the digital camera 2 may be displayed in the application information display section 52. The display of the portal screen is changed so that the user is allowed to easily search for an application being supported by the digital camera 2 that the user is connecting to the PC 1.

Further, the portal server 21 causes the button displayed adjacent to the icon representing the installed application to display “installed”. Also, the portal server 21 compares the version of the application installed in the digital camera 2 with the latest version of the same application that can be currently downloaded, and if the version of the installed application is older, the portal server 21 causes the button displayed adjacent to the icon representing the application to display a character string “Update”. As described with reference to FIG. 3, the portal server 21 manages information on the installed applications, and uses the information for updating the portal screen.

Thereby, it is possible for the user to easily distinguish an application installed on the digital camera 2 that the user is connecting from an application not installed. Also, it is possible for the user to easily confirm that there is an upgraded version of the installed application.

In step S149, the portal server 21 creates processing for a correlation ID, and makes a request to the license management server 23 for issuing a license. The information that is transmitted to the license management server 23 with the request for issuing a license includes, for example, the account ID “A” of the user of the PC 1, the application ID “P” of the application requested to be downloaded, and the information of “Dev1”, which is the device ID of the digital camera 2 to be a license issue destination.

In step S171, the license management server 23 receives the information transmitted from the portal server 21, and registers the account ID, the information on the application, and the device ID of the digital camera 2 in association with one another in step S172 so as to issue a license for the digital camera 2. The license management server 23 transmits information representing the contents of the license to the portal server 21.

The license management server 23 manages the account ID of the user, the device ID of the camera of the installation destination, and the application ID of the installed application, for example, in association with the correlation ID. The portal server 21 refers to the information managed in the license management server 23 so as to confirm which application has been installed, to which user, and to how many numbers of cameras. This confirmation is made by inquiries from the portal server 21 to the license management server 23 at predetermined timing.

In step S150, the portal server 21 receives the information transmitted from the license management server 23.

In step S151, if the camera information transmitted from the digital camera 2 does not include an account ID, the portal server 21 transmits an account ID with a command to the digital camera 2, and causes writing of the account ID. The account ID to be written into the digital camera 2 is the account ID that was input by the user of the PC 1 at sign-in time, which has been obtained in step S25 in FIG. 4.

In step S105, the digital camera 2 stores the account ID transmitted from the portal server 21 into a memory, and so on to manage the account ID as the camera information. As described later, it becomes possible to determine whether the user who signed in matches the owner of the camera to be an installation destination of the application using the account ID of the user that was input at sign-in time and the account ID managed as the camera information.

In step S152, the portal server 21 transmits an application URL for downloading the application to the digital camera 2. The application URL includes information indicating the application DL management server 22 as a connection destination.

In step S106, the digital camera 2 receives the application URL transmitted from the portal server 21, and accesses the application DL management server 22 on the basis of the application URL in step S107 (FIG. 7).

In step S161, the application DL management server 22 receives the access from the digital camera 2, and transmits a file specified by the application URL to the digital camera 2 in step S162. The file transmitted to the digital camera 2 stores data of the application.

In step S108, the digital camera 2 receives the file transmitted from the application DL management server 22, and installs the application in step S109.

In step S110, the digital camera 2 transmits the camera information to the portal server 21.

In step S153, the portal server 21 receives the information transmitted from the digital camera 2, and updates the portal screen in step S154. For example, the portal server 21 updates the portal screen so as to display a character string “installed” on the button displayed adjacent to the icon representing a newly installed application.

Also, if there is an application that is related to the installed application, but is not yet installed, the portal server 21 displays information stating that there is such an application on the portal screen.

As described above, the user is allowed to easily download an application for the digital camera 2 by operation of the browser of the PC 1.

If the remaining amount of the battery of the digital camera 2 is little, it is possible not to allow installation of an application. For example, the portal server 21 confirms the remaining amount of the battery, which is included in the camera information transmitted from the digital camera 2 in step S105 in FIG. 6, and if the remaining amount is less than a threshold value, the installation of the application is terminated. Thereby, it is possible to prevent shortage of the battery of the digital camera 2 during the installation, and the occurrence of a problem.

Determination Processing of Portal Server 21

Here, descriptions will be given of the determination processing in step S147 in FIG. 6, and an example of the portal screen updated in step S148 on the basis of the determination result.

Determination Processing 1

The portal server 21 determines whether the account ID included in the camera information and the account ID of the user of the PC 1 match or not. The former account ID is included in the camera information received in step S146, and the latter account ID is received in step S25 in FIG. 4. That both of the account IDs match represents that the user of the PC 1 who has signed in matches the owner of the digital camera 2 connected to the PC 1.

If the account ID included in the camera information and the account ID of the user of the PC 1 match, the portal server 21 continues to download the application as described above.

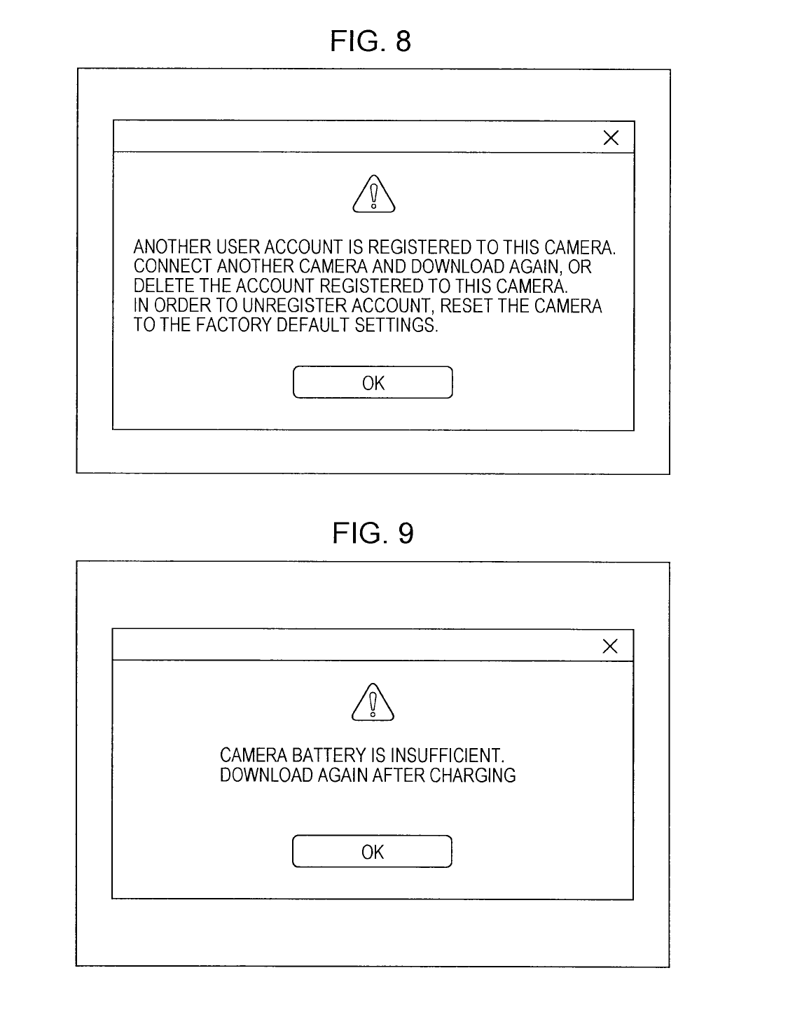

Also, if both of the account IDs do not match, the portal server 21 displays a message illustrated in FIG. 8 on the portal screen in step S148, and suspends downloading of the application. In the example in FIG. 8, a message notifying that the account ID written in the camera is different from the account ID of the user of the PC 1 is displayed.

Thereby, it becomes possible to prevent a user who has signed in and purchased an application from downloading the application to a camera of another person.

Determination Processing 2

The portal server 21 determines whether the remaining amount of the battery of the digital camera 2 to which the application is downloaded is sufficient or not. The camera information received in step S146 includes information indicating the remaining amount of the battery of the digital camera 2 as described with reference to FIG. 2.

The portal server 21 identifies the remaining amount of the battery of the digital camera 2 on the basis of the information included in the camera information. If the remaining amount of the battery of the digital camera 2 is greater than the threshold value, the portal server 21 continues to download the application as described above.

Also, if the remaining amount of the battery of the digital camera 2 is less than the threshold value, the portal server 21 displays a message illustrated in FIG. 9 on the portal screen in step S148, and suspends the download of the application. In the example in FIG. 9, a message notifying that the battery of the digital camera 2 is insufficient is displayed.

Thereby, it becomes possible to prevent the occurrence of a problem in that the battery of the digital camera 2 runs out during the download of the application or during installation of the downloaded application, which results in a failure of starting.

Determination Processing 3

The portal server 21 determines whether there is a sufficient free space or not in the memory of the digital camera 2 to which the application is downloaded. The camera information received in step S146 includes information indicating a free space in the memory of the digital camera 2 as described with reference to FIG. 2.

The portal server 21 identifies a free space of the memory of the digital camera 2 on the basis of the information included in the camera information. If the free space of the memory is greater than the data amount of the application, the portal server 21 continues to download the application as described above.

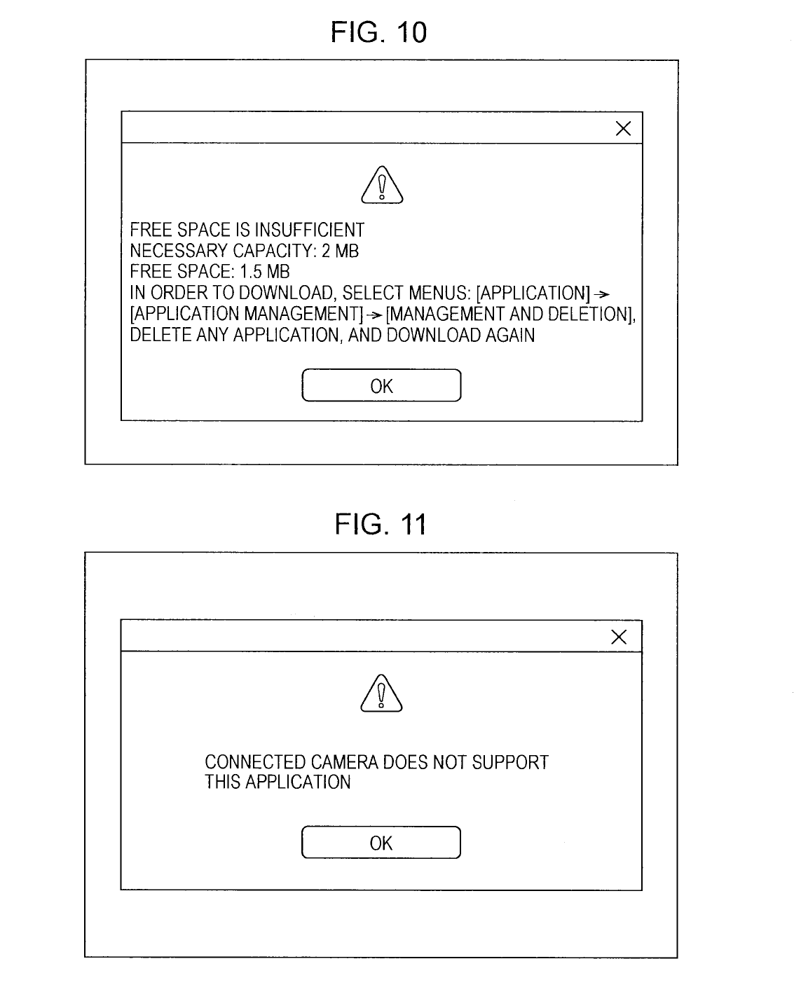

Also, if the free space of the memory is less than the data amount of the application, the portal server 21 displays a message illustrated in FIG. 10 on the portal screen in step S148, and suspends the download of the application. In the example in FIG. 10, the data amount of the application is 2 MB, whereas the free space of the memory of the digital camera 2 is only 1.5 MB. And thus, a message notifying the user of shortage of free space is displayed. That the free space is 1.5 MB is identified on the basis of the information included in the camera information.

Thereby, it becomes possible to prevent the digital camera 2 with insufficient free space in the memory from executing the download.

Determination Processing 4

The portal server 21 determines whether it is possible to install the application that is requested to be downloaded in the digital camera 2 or not. Depending on a model of a camera, there are operable applications and inoperable application. A determination is made of whether an application requested to be downloaded is supported by the digital camera 2 or not.

As described with reference to FIG. 2, the camera information includes information indicating the model name of the digital camera 2. The portal server 21 includes information indicating supporting models of each application in advance.

The portal server 21 identifies a model of the digital camera 2 on the basis of the information included in the camera information. If the portal server 21 determines that the application requested to be downloaded is supported by the digital camera 2, the portal server 21 continues downloading of the application as described above.

Also, if the portal server 21 determines that the application requested to be downloaded is not supported by the digital camera 2, the portal server 21 displays a message illustrated in FIG. 11 on the portal screen in step S148, and suspends downloading of the application. In the example in FIG. 11, a message notifying the user that the application requested to be downloaded is not supported by the digital camera 2 is displayed.

Thereby, it becomes possible to prevent an application not supported from being downloaded.

Determination Processing 5

The portal server 21 determines whether the version of the firmware of the digital camera 2 supports the application requested to be downloaded or not. Depending on the version of the firmware, there are versions that allow running the application, and versions that do not allow running the application.

As described with reference to FIG. 2, the camera information includes information indicating the versions of the firmware of the digital camera 2. The portal server 21 has information indicating the versions of the firmware supporting each application in advance.

The portal server 21 identifies the version of the digital camera 2 on the basis of the information included in the camera information. If the portal server 21 determines that the version of the firmware of the digital camera 2 supports the application requested to be downloaded, the portal server 21 continues to download the application as described above.

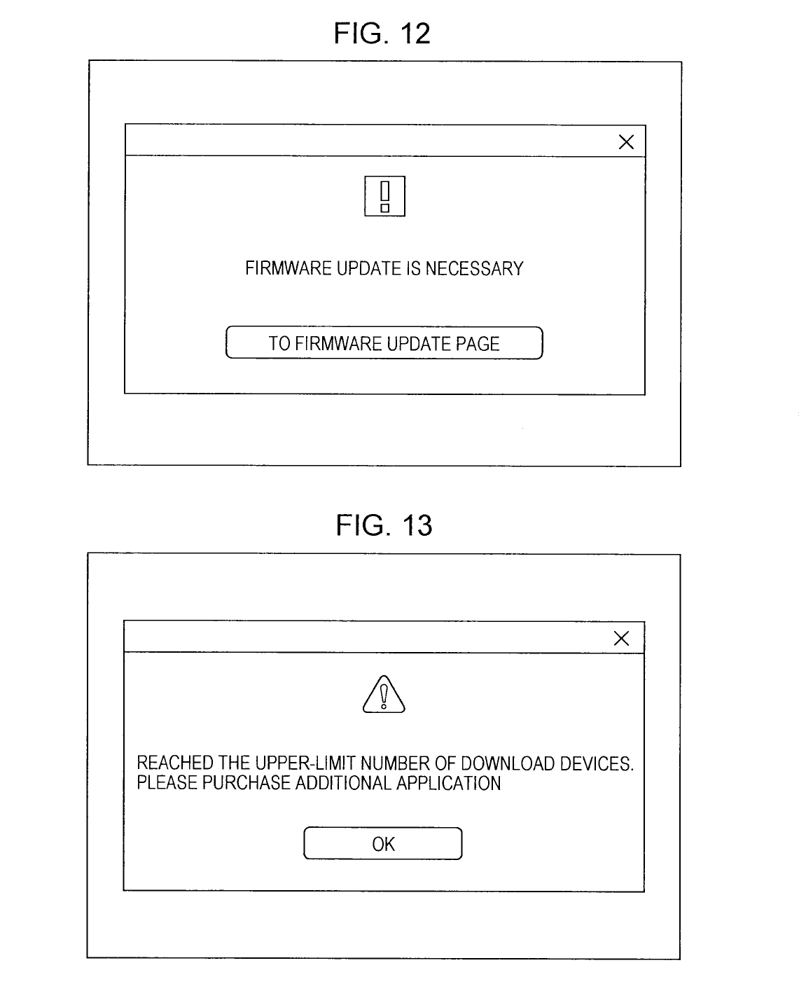

Also, if the portal server 21 determines that the version of the firmware of the digital camera 2 does not support the application requested to be downloaded, the portal server 21 causes to display a message illustrated in FIG. 12 on the portal screen in step S148, and suspends downloading of the application. In the example of FIG. 12, a message notifying the user of necessity of the version-up of the firmware of the digital camera 2 is displayed.

Thereby, it becomes possible to prevent an application not supported by the firmware of the digital camera 2 from being downloaded.

Determination Processing 6

The portal server 21 determines whether there remains a license for the application requested to be downloaded or not. For a purchased application, licenses that enable the user to install the application into a predetermined number of devices, for example up to 10 devices, are issued and managed by the license management server 23.

The portal server 21 makes an inquiry to the license management server 23 on the basis of the account ID of the user of the PC 1, for example, and confirms the number of cameras on which the application requested to be downloaded is installed. As described above, the license management server 23 manages the account IDs of the users, the device IDs of the cameras on which the application is installed, and the application IDs of the installed applications in association with one another.

If the portal server 21 determines that there remains a license for the application requested to be downloaded (the number of installations has not reached the upper limit), the portal server 21 continues to download the application as described above.

Also, if the portal server 21 determines that there remains no license for the application requested to be downloaded, the portal server 21 causes to display a message illustrated in FIG. 13 in step S148 on the portal screen, and suspends the downloading of the application. For example, if it is assumed that licenses that enable the user to install the application into 10 devices by purchasing an application are issued, when a 11-th camera is to be installed, a determination is made that there remains no license.

In the example in FIG. 13, a message notifying that the number of installations of the application has reached the upper limit number, and a message notifying that installation becomes possible by an additional purchase are displayed. By purchasing the same application again, a license is additionally issued.

Thereby, it becomes possible to prevent one application from being installed on the number of cameras that exceed the upper limit number.

Display Example of Portal Screen

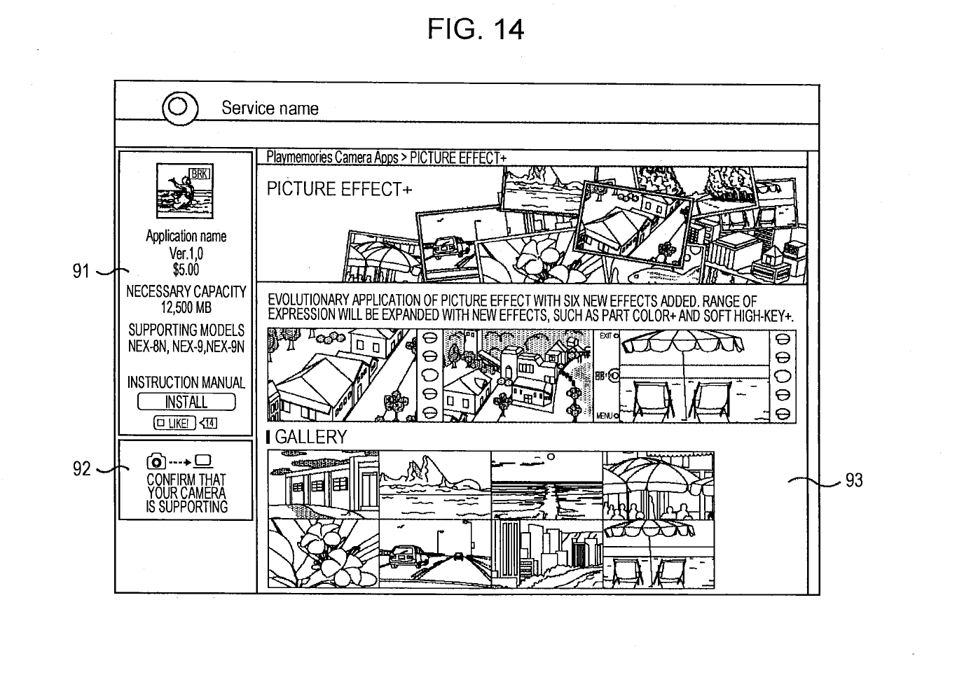

FIG. 14 is a diagram illustrating an example of a detailed screen of an application.

In the detailed screen of the application, information on the application selected on the screen in FIG. 5 is displayed. For example, when an icon representing an application in the screen in FIG. 5 is selected or when a button displayed adjacent to the icon is operated, the detailed screen is displayed. In the example in FIG. 14, it is assumed that sign-in has been complete.

On the left end of the detailed screen, a basic information section 91, which is a display area of the basic information, such as an icon, a name of an application, and so on, is formed. A confirmation button 92 is displayed under the basic information section 91. The confirmation button 92 is a button which is operated when the user checks whether the digital camera 2 connected to the PC 1 is a model supporting the application that the user has selected or not.

A description display section 93 is formed on the right side of the basic information section 91. If the selected application is about a shooting function, sample images shot using that function, and so on are displayed in addition to a text of the description of the selected application in the description display section 93.

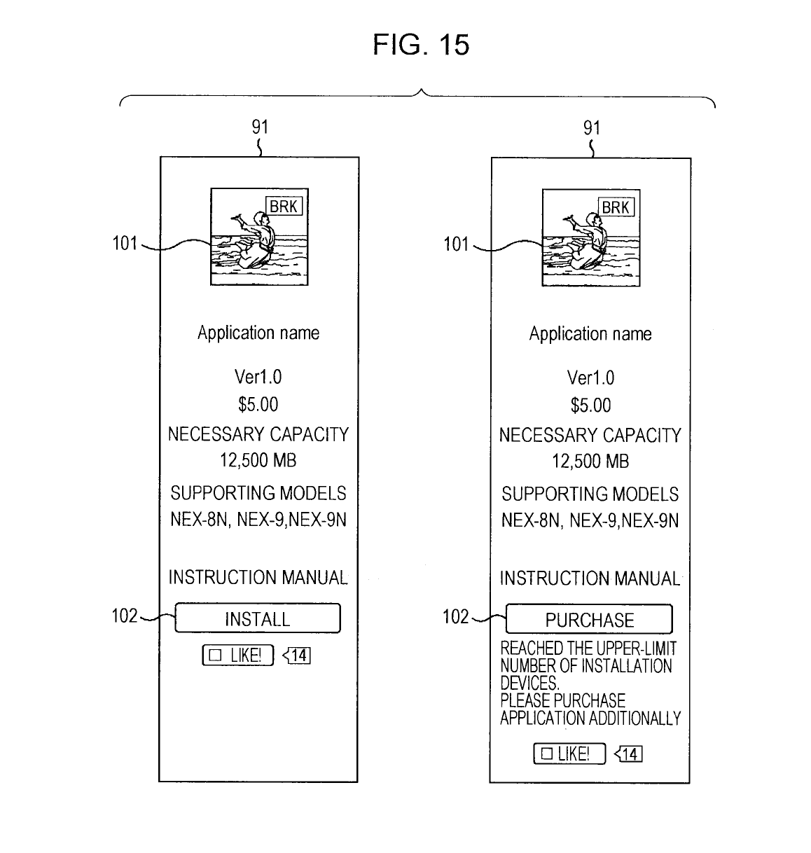

FIG. 15 is a diagram illustrating enlarged views of the basic information sections 91 in FIG. 14.

An icon 101 is displayed in the upper part of the basic information section 91, and a name of the selected application, a version, a sales price, a free space of the memory necessary for installation, and information on supporting models are displayed under the icon 101. An operation button 102 is displayed under the information on supporting models. As illustrated on the left side and the right side in FIG. 15, a character string displayed on the operation button 102 is changed in accordance with the status.

If the selected application has been purchased, and there remains a license, a character string “Install” is displayed on the operation button 102 as illustrated on the left side in FIG. 15. When the operation button 102 on which the character string “Install” is displayed is operated, downloading and installation of the application is carried out as described with reference to FIG. 6. When the installation is complete, a character sting “Installed” is displayed on the operation button 102.

On the other hand, if the application has been purchased, but there remains no license, as illustrated on the right side in FIG. 15, a character string “Purchase” is displayed on the operation button 102. Also, a message stating that the number of installations of the application has reached the upper limit, and thus prompting to purchase an additional application is displayed under the operation button 102.

As described above, if the number of installations of the application has reached the upper limit, it becomes possible to install the application by an additional purchase. When the operation button 102 on which the character string “Purchase” is operated, for example, the processing of step S4 in FIG. 4 and after that, which is application purchase processing, is performed.

About processing when confirmation button is operated after purchasing application

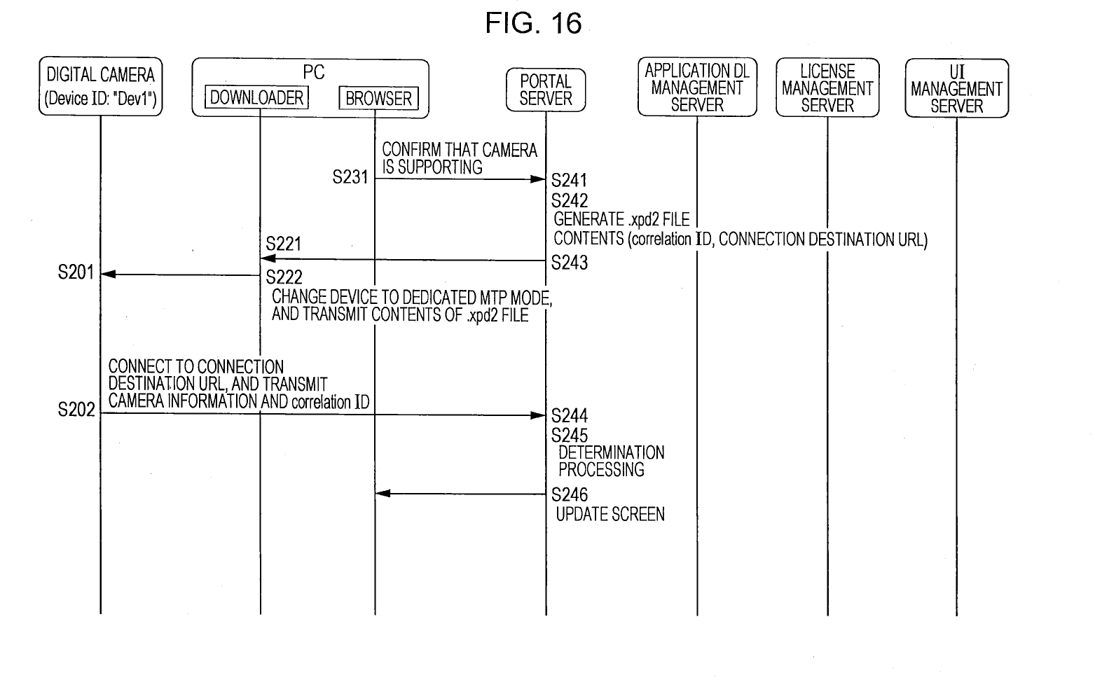

Next, a description will be given of processing when the confirmation button 92 is operated on the detailed screen in FIG. 14 with reference to a flowchart in FIG. 16. It is assumed that the digital camera 2 is connected to the PC 1. Also, it is assumed that the confirmation button 92 is operated in the detailed screen of the purchased application.

In step S231, the browser of the PC 1 transmits information indicating a request for confirmation of whether the selected application is supported by the digital camera 2 or not to the portal server 21 in response to the operation of the confirmation button 92 by the user.

In step S241, the portal server 21 receives the information transmitted from the browser of the PC 1. In step S242, the portal server 21 generates the .xpd2 file. The .xpd2 file includes a correlation ID, and a connection destination URL. The connection destination URL represents an address on the portal server 21 for displaying a confirmation result. In step S243, the portal server 21 transmits the .xpd2 file to the PC 1.

In step S221, the downloader of the PC 1 is started in response to the transmission of the .xpd2 file. In step S222, the downloader changes the digital camera 2 to the MTP mode, and transfers the correlation ID and the connection destination URL included in the .xpd2 file to the digital camera 2.

In step S201, the digital camera 2 receives the information transmitted from the PC 1.

In step S202, the digital camera 2 connects to the portal server 21 specified by the connection destination URL, and transmits the camera information and the correlation ID.

In step S244, the portal server 21 receives the camera information and the correlation ID that are transmitted from the digital camera 2, and performs determination processing using the camera information in step S245. In step S246, the portal server 21 updates the detailed screen of the application in accordance with a result of the determination processing.

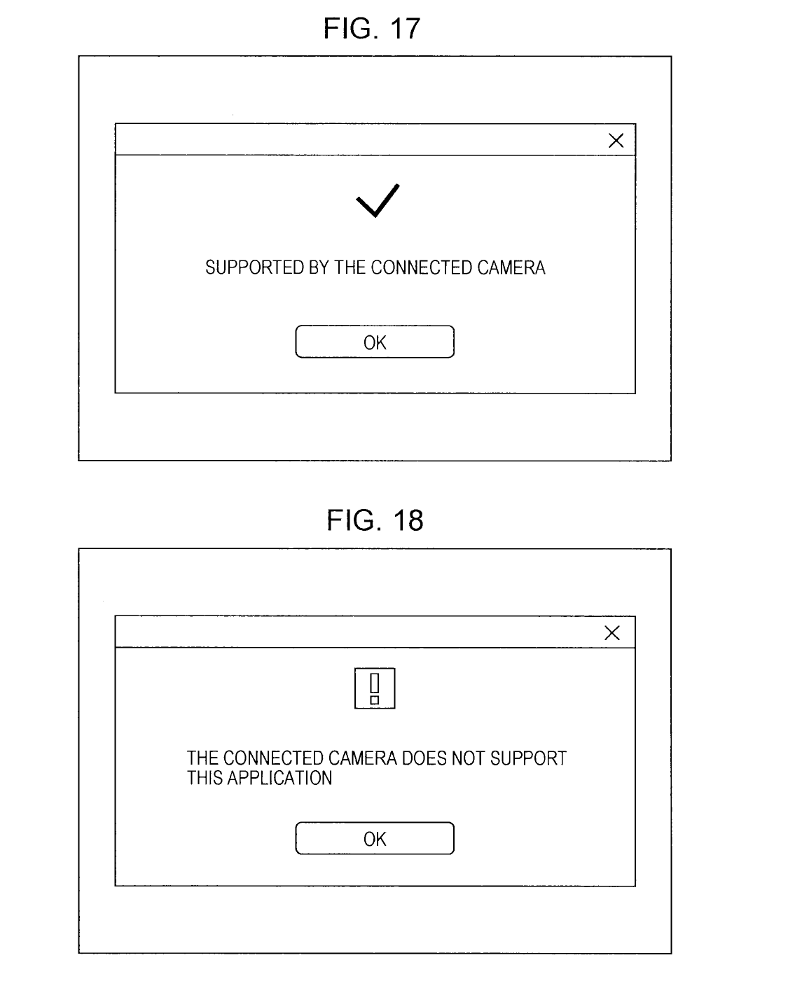

FIG. 17 is a diagram illustrating an example of a message which is displayed on the detailed screen in the case where the selected application is determined to be supported by the digital camera 2. The portal server 21 identifies the model of the digital camera 2 on the basis of the information included in the camera information, and refers to the information indicating the model supporting each application to determine whether the application is supported or not.

In the example in FIG. 17, a message notifying that the selected application is supported by the digital camera 2 is displayed. After that, the user operates the operation button 102 on which the character string “Install” is displayed to install the application.

FIG. 18 is a diagram illustrating an example of a message which is displayed on the detailed screen in the case where the selected application is determined to be not supported by digital camera 2. In the example in FIG. 18, a message notifying that the selected application is not supported by the digital camera 2 is displayed.

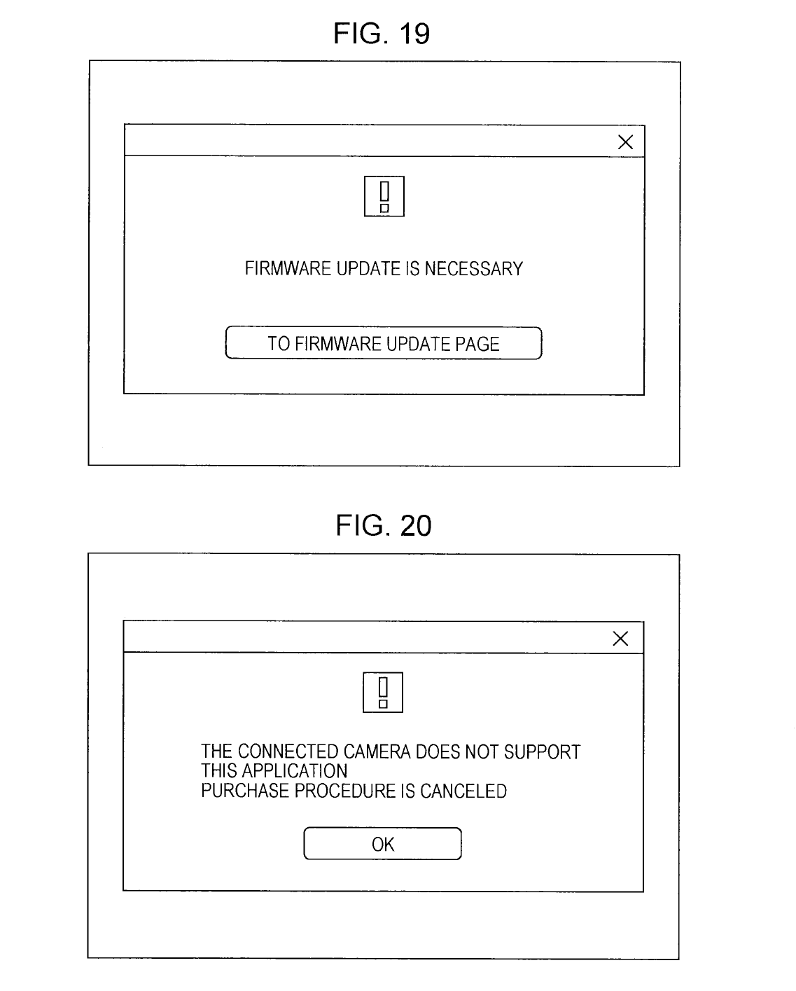

FIG. 19 is a diagram illustrating an example of a message which is displayed on the detailed screen in the case where the version of the firmware of the digital camera 2 is determined to be not supporting the selected application. The portal server 21 identifies the version of the firmware of the digital camera 2 on the basis of the information included in the camera information, and refers to the information indicating the version supporting each application to determine whether the application is supported or not.

In the example in FIG. 19, a message notifying the user that version-up is necessary for the firmware of the digital camera 2 is displayed.

Thereby, it is possible for the user to check whether it is possible to install the purchased application in the connected digital camera 2.

About processing when confirmation button is operated before purchasing application

It is possible to check whether the selected application is supported or not by the digital camera 2 before purchasing the application.

After the user signed in from the PC 1, the same processing as that described with reference to FIG. 16 is performed. The portal server 21 performs various kinds of determination processing (step S245) on the basis of the information included in the camera information transmitted from the digital camera 2, and changes the display of the detailed screen in accordance with the determination result (step S246).

FIG. 20 is a diagram illustrating an example of a message which is displayed on the detailed screen in the case where the selected application is determined to be not supported by the digital camera 2. The portal server 21 identifies the model of the digital camera 2 on the basis of the information included in the camera information, refers to the information indicating the supporting models of each application, and determines whether the application is supported or not.

In the example in FIG. 20, a message notifying that the selected application is not supported by the digital camera 2, and thus the purchase procedure is suspended is displayed.

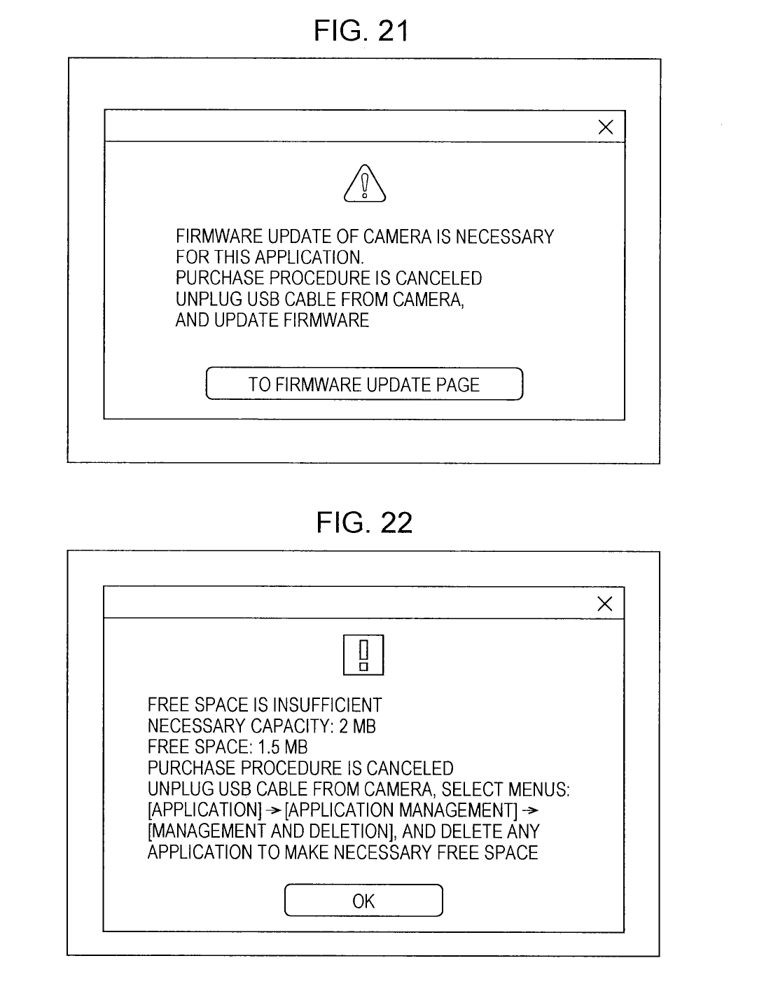

FIG. 21 is a diagram illustrating an example of a message that is displayed on the detailed screen in the case where the version of the firmware of the digital camera 2 does not support the selected application. The portal server 21 identifies the version of the firmware of the digital camera 2 on the basis of the information included in the camera information, refers to information indicating the versions supporting each application, and determines whether the application is supported or not.

In the example in FIG. 21, a message notifying the user that the firmware version-up of the digital camera 2 is necessary, and a message suspending the purchase procedure are displayed.

FIG. 22 is a diagram illustrating an example of a message that is displayed on the detailed screen in the case where the free space of the memory of the digital camera 2 is determined to be insufficient for downloading the selected application. The portal server 21 identifies the free space of the memory of the digital camera 2 on the basis of the information included in the camera information, compares the free space with the amount of data of the selected application, and determines whether there is sufficient free space or not.

In the example in FIG. 22, the amount of data of the application is 2 MB, whereas the free space of the memory of the digital camera 2 is only 1.5 MB, and thus a message notifying that the free space is insufficient, and a message notifying that the purchase procedure is suspended are displayed.

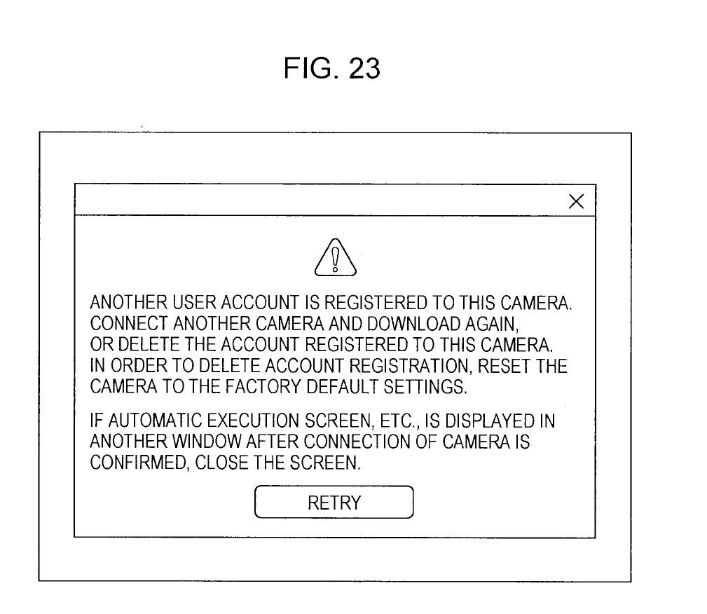

FIG. 23 is a diagram illustrating an example of a message which is displayed on the detailed screen in the case where a determination is made that the account ID included in the camera information and the account ID of the user of the PC 1 do not match. In the example of FIG. 23, a message notifying the user that the account ID written in the camera is different from the account ID of the user of the PC 1 is displayed.

Thereby, it is possible for the user to check whether the application to be purchased can be installed in the connected digital camera 2.

Configuration of Individual Devices

Next, descriptions will be given of configurations of individual devices that perform the above-described processing.

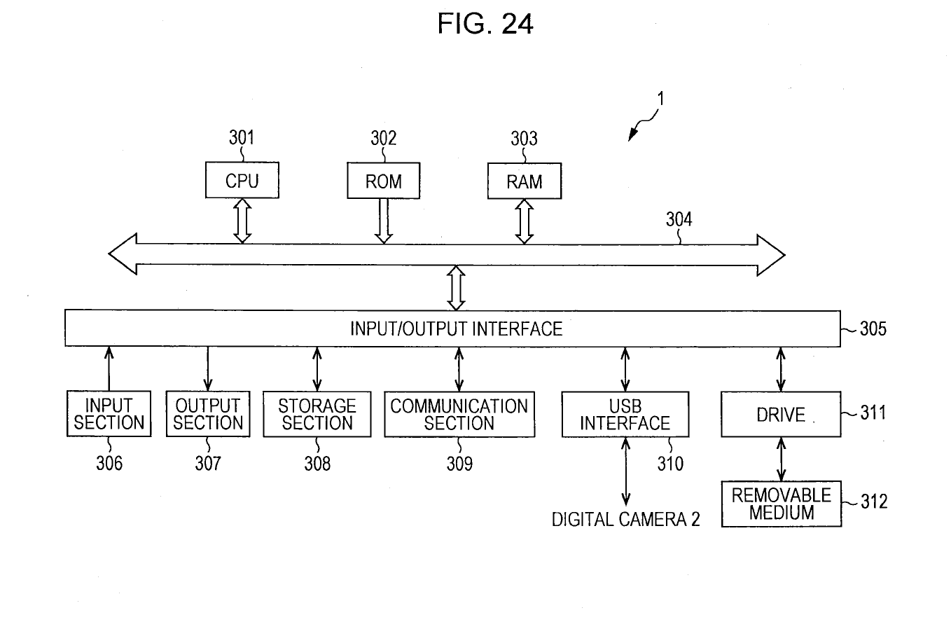

FIG. 24 a block diagram illustrating an example of a hardware configuration of the PC 1.

A CPU (Central Processing Unit) 301, a ROM (Read Only Memory) 302, and a RAM (Random Access Memory) 303 are mutually connected through a bus 304.

An input/output interface 305 is further connected to the bus 304. An input section 306 including a keyboard, mouse, and so on, and an output section 307 including a display, a speaker, and so on are connected to the input/output interface 305. Also, a storage section 308 including a hard disk, a nonvolatile memory, and so on, a network section 309 performing communication with the servers through the network 11, and a USB interface 310 performing communication with the digital camera 2 through the USB cable 3 are connected to the input/output interface 305. A drive 311 that drives a removable medium 312 is also connected to the input/output interface 305.

The portal server 21 to the UI management server 24 include the same configuration as that of the PC 1 illustrated in FIG. 24. Hereinafter a description will be given by suitably referring the configuration illustrated in FIG. 24 as the configurations of the portal server 21 to the UI management server 24.

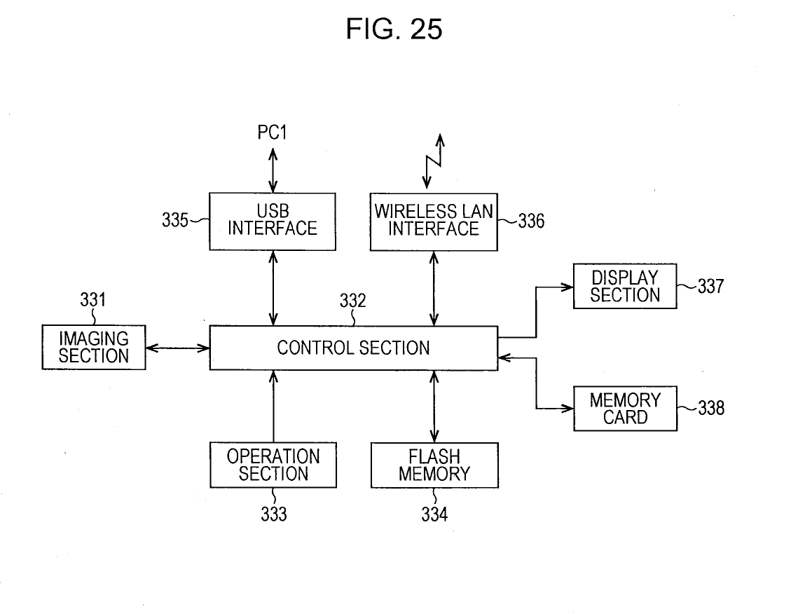

FIG. 25 is a block diagram illustrating an example of a hardware configuration of the digital camera 2.

The imaging section 331 includes a lens, an imaging element, and so on, and captures images under the control of a control section 332. The imaging section 331 outputs image data obtained by capturing images to the control section 332.

The control section 332 includes a CPU, a RAM, and so on, and reads and executes a predetermined program stored in a flash memory 334, and so on, to control the overall operation of the digital camera 2 in accordance with operation by the user on an operation section 333. For example, the control section 332 outputs the image data supplied from the imaging section 331 to the flash memory 334 and a memory card 338 to store the image data. Also, the control section 332 outputs the image data to the display section 337 to display the image. The control section 332 performs communication with the PC 1 through the USB interface 335, and performs installation of the application transmitted from the PC 1, and so on.

The operation section 333 includes buttons disposed on a case of the digital camera 2, and a touch panel disposed by being laminated on the display section 337, and so on, and outputs a signal representing the contents of user operation to the control section 332.

The flash memory 334 stores various kinds of data, such as application data and image data, and so on, which are supplied from the control section 332.

The USB interface 335 performs communication with the PC 1 through the USB cable 3. The USB interface 335 transmits the information supplied from the control section 332, and receives the information transmitted from the PC 1 to the control section 332.

A wireless LAN interface 336 connects to the network 11 through an access point, and performs communication with the servers on the network 11.

The display section 337 includes an LCD (Liquid Crystal Display), and so on, and displays an image on the basis of the data supplied from the control section 332, and displays various screens, such as a menu screen, a Web screen, and so on.

The memory card 338 stores the data supplied from the control section 332. The data stored in the memory card 338 is suitably read by the control section 332.

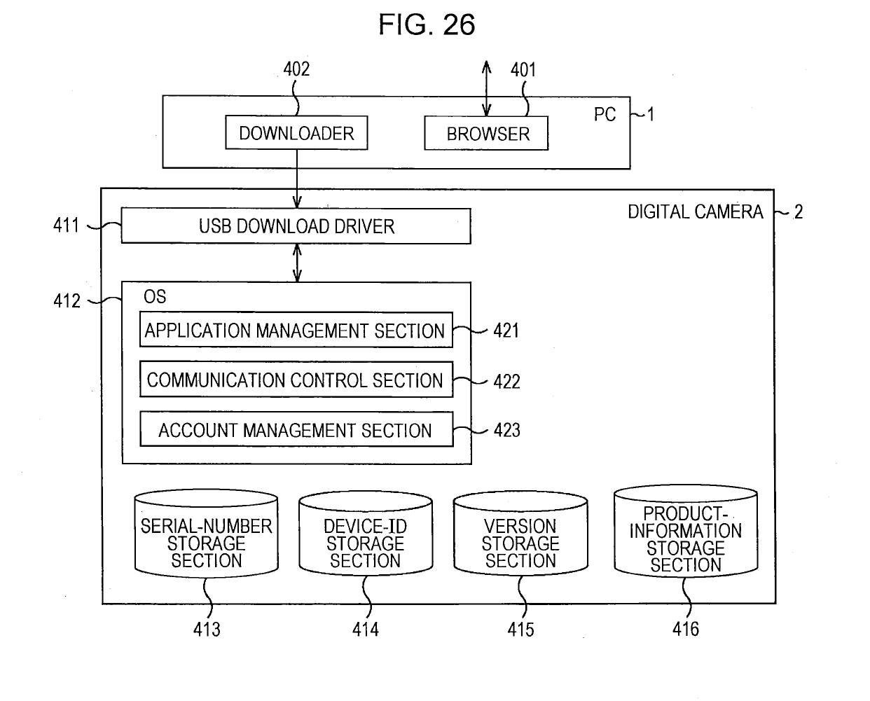

FIG. 26 is a block diagram illustrating an example of functional configurations of the PC 1 and the digital camera 2.

The PC 1 is provided with a browser 401 and a downloader 402, which is a plug-in of the browser 401.

In the digital camera 2, a USB download driver 411, an OS 412, a serial-number storage section 413, a device-ID storage section 414, a version storage section 415, and a product-information storage section 416 are achieved. In the OS 412, an application management section 421, a communication control section 422, and an account management section 423 are achieved. For example, the serial-number storage section 413, the device-ID storage section 414, the version storage section 415, and the product-information storage section 416 are achieved in the flash memory 134 in FIG. 25.

The USB download driver 411 controls the USB interface 335 in FIG. 25, and controls the communication with the portal server 21, and so on through the PC 1.

The application management section 421 in the OS 412 performs management of installation of applications (step S109 in FIG. 7), and so on. The communication control section 422 controls communication with the portal server 21, and so on. For example, the processing of step S101 to S108 and S110 in FIG. 6 is controlled by the communication control section 422. The account management section 423 manages account IDs.

The serial-number storage section 413 stores serial numbers of the digital cameras 2. The device-ID storage section 414 stores device IDs of the digital cameras 2. The version storage section 415 stores firmware versions of the digital cameras 2. The product-information storage section 416 stores camera names. The storage contents of the serial-number storage section 413, the device-ID storage section 414, the product-information storage section 416, and so on are used for the camera information in FIG. 2.

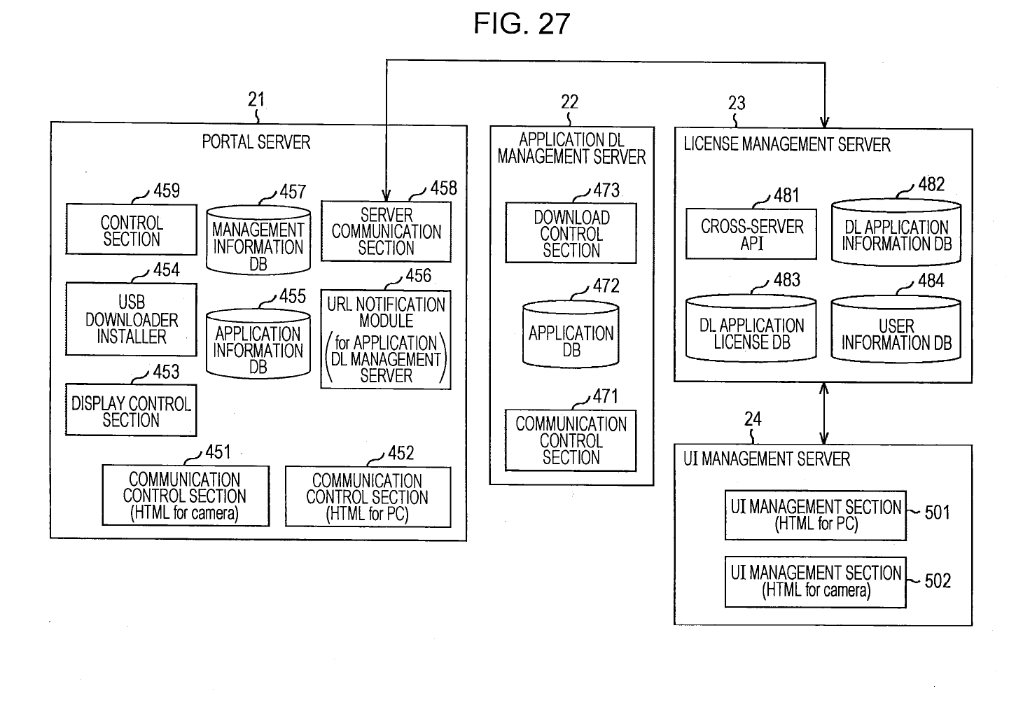

FIG. 27 is a block diagram illustrating examples of functional configurations of the portal server 21, the application DL management server 22, the license management server 23, and the UI management server 24. The functional configurations of the individual servers illustrated in FIG. 27 are achieved by the CPUs included in the servers executing predetermined programs.

In the portal server 21, a communication control section 451, a communication control section 452, a display control section 453, a USB downloader installer 454, an application information DB 455, a URL notification module 456, a management information DB 457, a server communication section 458, and a control section 459 are achieved.

The communication control section 451 controls communication with the digital camera 2. For example, the processing of S144 to S146 and S151 to S153 in FIG. 6 is controlled by the communication control section 451.

The communication control section 452 controls communication with the PC 1. For example, the processing in steps S21 and S27 in FIG. 4, and the processing in steps S141 and S143 in FIG. 6 is controlled by the communication control section 452.

The display control section 453 performs communication with the PC 1 through the communication control section 452, and controls display of the portal screen. For example, the processing of steps S26 and S32 in FIG. 4, step S148 in FIG. 6, and step S154 in FIG. 7 is controlled by the display control section 453.

The USB downloader installer 454 controls installation of the downloader 402. If the downloader 402 is not installed in the PC 1, the USB downloader installer 454 transmits the data of the downloader 402 to the browser 401 to install the downloader 402.

The application information DB 455 stores information of downloadable applications. A portal screen is displayed using the information stored in the application information DB 455.

The URL notification module 456 controls notification of an application URL. For example, the processing in step S152 in FIG. 6 is controlled by the URL notification module 456.

The management information DB 457 stores the management information illustrated in FIG. 3.

The server communication section 458 controls communication with the license management server 23 and the UI management server 24. For example, the processing of steps S22 to S25, S28, S29, S30, and S31 in FIG. 4, and the processing of step S149 and S150 in FIG. 6 is controlled by the server communication section 458. The communication between the portal server 21 and the UI management server 24 is performed through the license management server 23.

The control section 459 controls the processing, such as generation (step S142 in FIG. 6) of the .xpd2 file, confirmation (step S144) of a client, determination processing (step S147) using the camera information, and so on.

In the application DL management server 22, the communication control section 471, the application DB 472, and the download control section 473 are achieved.

The communication control section 471 controls communication with the digital camera 2. For example, the processing in steps S161 and S162 in FIG. 7 is controlled by the communication control section 471.

The application DB 472 stores application data. The data stored in the application DB 472 is read, and transmitted to the digital camera 2 by the communication control section 471.

The download control section 473 controls downloading of applications. For example, the processing in step S162 in FIG. 7 is controlled by the download control section 473.

In the license management server 23, a cross-server API 481, a DL application information DB 482, a DL application license DB 483, and a user information DB 484 are achieved.

The cross-server API 481 controls communication with the portal server 21. The cross-server API 481 controls the processing of steps S41 to S44 in FIG. 4, and the processing of steps S171 and S172 in FIG. 6.

The DL application information DB 482 stores information of downloaded applications in association with the account ID.

The DL application license DB 483 stores information on licenses of applications in association with the account ID.

The user information DB 484 stores information, such as an account ID registered by each user, a password, an e-mail address, a credit card number, and so on. The data stored in the DL application information DB 482, the DL application license DB 483, and the DL application license DB 483 are suitably read by the cross-server API 481, and are transmitted to the portal server 21 and so on.

In the UI management server 24, the UI management section 501 and the UI management section 502 are achieved.

The UI management section 501 controls display of the UI for the user of the PC 1. The UI management section 501 controls the processing of steps S51 to S58 in FIG. 4.

The UI management section 502 controls the UI of the digital camera 2.

Variations

In the above, the application is transferred from the PC 1 to the digital camera 2 by the downloader as a plug-in of the browser. However, a downloaded application may be transferred by a combination of a plug-in and a normal PC application.

Also, it is possible to transfer a downloaded application only by a PC application. In this case, in order for the PC application to receive a URL, such as a connection destination URL generated by the server, and so on, setting is carried out for the OS of the PC 1 to tie a specific extension file to this PC application. Also, setting is carried out in order to perform automatic execution of the file when the specific extension file is downloaded. After these settings are carried out in the PC 1, the server writes a URL, such as a connection destination URL, and so on, into the specific extension file, and the file is downloaded to the browser in response to download operation of the application by the user.

The above-described series of processing can be executed by hardware or can be executed by software. When the series of processing is executed by software, programs constituting the software may be installed in a computer that is built in a dedicated hardware, or a general-purpose personal computer, etc.

The programs to be installed are provided in such a manner as recorded in the removable medium 312 illustrated in FIG. 24, for example, an optical disc (a CD-ROM (Compact Disc-Read Only Memory), a DVD (Digital Versatile Disc), and so on), a semiconductor memory, and so on. Also, the programs may be provided through a wired or wireless transmission medium, such as a local area network, the Internet, and digital broadcasting. The programs may be installed in the ROM 302 or the storage section 308 in advance.

In this regard, the programs executed on the computer may be programs executed in time series in accordance with the sequence described in this specification, or may be executed in parallel or at necessary timing, such as at the time of being called, or the like.

In this regard, in the present specification, a system means a set of a plurality of components (apparatuses, modules (parts), and so on), and it does not matter whether all the components are contained in a same case or not. Accordingly, a plurality of apparatuses that are accommodated in separate cases and connected through a network, and a plurality of modules accommodated in one case are both systems.

An embodiment of the present technique is not limited to the above-described embodiments. It is possible to make various changes without departing from the gist of the present technique.

For example, it is possible to configure the present technique in a cloud computing environment, in which one function is shared and coordinated by a plurality of apparatuses through a network.

Also, each step in the flowchart described above can be shared and executed by a plurality of apparatuses in addition to be executed by one apparatus.

Further, in the case where one step includes a plurality of processing, the plurality of processing included in the one step can be shared and executed by a plurality of apparatuses in addition to be executed by one apparatus.

The present disclosure contains subject matter related to that disclosed in Japanese Priority Patent Application JP 2012-187081 filed in the Japan Patent Office on Aug. 27, 2012 and Japanese Priority Patent Application JP 2012-218760 filed in the Japan Patent Office on Sep. 28, 2012, the entire contents of which are hereby incorporated by reference.

What is claimed is:

1. A mobile terminal comprising:
a reception section configured to receive an application downloaded from a server by operation of a browser in an information processing apparatus and transmitted through the information processing apparatus; and
a management section configured to install the application received by the reception section.

2. The mobile terminal according to claim 1, further comprising being connected to the information processing apparatus through a USB cable,
wherein the reception section is configured to receive the application transmitted through the USB cable.

3. A method of processing information, the method comprising:
receiving an application downloaded from a server by operation of a browser in an information processing apparatus, and transmitted through the information processing apparatus; and
installing the application received by a reception section.

4. An information processing apparatus comprising:
a display section configured to access a server, and to display a selection screen of an application for a mobile terminal by a browser function; and
a transmission section configured to transmit the application selected on the selection screen and downloaded to the mobile terminal by a plug-in function of the browser.

5. The information processing apparatus according to claim 4, further comprising being connected to the mobile terminal through a USB cable,
wherein the transmission section is configured to transmit the application through the USB cable.

6. A method of processing information, the method comprising:
accessing a server, and displaying a selection screen of an application for a mobile terminal by a function of a browser; and
transmitting the application selected on the selection screen and downloaded to the mobile terminal by a plug-in function of the browser.
